(19) United States
(12) Patent Application Publication
(10) Pub. No.: US 2005/0042576 A1
(43) Pub. Date: Feb. 24, 2005

(54) Dental article forms and methods

(76) Inventors: Joel D. Oxman, Minneapolis, MN (US); Naimul Karim, Maplewood, MN (US); Steven C. Keck, Falcon Heights, MN (US)

Correspondence Address: 3M INNOVATIVE PROPERTIES COMPANY, PO BOX 33427, ST. PAUL, MN, 55133-3427, US

(21) Appl. No.: 10/643,748

(22) Filed: Aug. 19, 2003

(51) Int. Cl. A61C 5/08

(52) U.S. Cl. 433/218

(57) ABSTRACT

Compositions, particularly for forming dental article forms, having a self-supporting structure with sufficient malleability to be subsequently customized into a second shape and then optionally cured, and methods.

### FIELD OF THE INVENTION

This invention relates to pre-shaped (or customed shaped) forms for making dental articles such as crowns, inlays, onlays, and other restoratives, and methods of making and using. These forms have sufficient internal strength to be formed into a desired shape that can be maintained during transportation and storage, can be filled with one or more hardenable dental resins, and possess sufficient malleability to be subsequently customized under conditions of the oral environment (e.g., oral fluids and temperatures). A desired customized dental article is obtained by allowing the hardenable dental resin to harden.

### BACKGROUND

Restorative dentistry is an important market in today's dental industry. In particular, tooth repair with temporary and permanent crowns is a common procedure, typically requiring multiple dental appointments. Current technology uses hardenable pastes, reactive two-part powder/liquid systems, preformed metal temporary crowns, and ceramic or porcelain/metal permanent crowns.

A typical procedure for making a provisional (i.e., temporary) dental restorative involves the following steps. Initially, an alginate impression is taken before preparing the teeth. The impression is rinsed, set aside, and wrapped in a moist paper towel. The teeth are then prepared and the correct shade of acrylic powder is selected to match the natural teeth. An acrylic liquid resin and the acrylic polymeric powder, one of which includes a reducing agent and the other of which includes an oxidizing agent, are mixed together and placed in the impression. The impression is placed aside until the composition thickens and forms a dull appearance (approximately 45-60 seconds). Meanwhile, the prepared teeth and surrounding tissue are coated with a petroleum jelly, which ensures easy removal of the acrylic temporary from the preparation and protects the teeth and tissue from irritation by the acrylic mixture. The impression with the acrylic mixture is seated in the mouth and held in place for a sufficient time to allow it to harden to a removable state. The acrylic material is removed from the impression and gross excess acrylic is trimmed. The acrylic material is placed in and out of the mouth while the acrylic material is in a rubbery state. The acrylic material is removed from the mouth and set aside until the acrylic is fully cured. The fit of the acrylic restorative is checked and adapted to fit, if necessary. Excess acrylic is trimmed with an acrylic bur or stone and polished to a smooth finish. The acrylic temporary is then cemented into place.

It would be desirable to have dental article forms that are thin-walled such that the article form can be removed after having hardened the dental resin. As a result, the thinner wall will leave behind a smaller gap between proximal teeth, as well as between the opposing tooth. If the dental article form is not removed then thickness is less of an issue. It would also be desirable to have dental article forms that are preformed into a desirable shape (e.g., an anatomical or other customized shape), are suitable for being filled with one or more hardenable dental materials, are sufficiently malleable, particularly under conditions of the mouth, to be reformed into a second shape, and following hardening of the dental material, provide a custom-shaped dental article. Such dental article forms would eliminate the necessity to use a dental impression and would eliminate the need for a significant number of sizes and shapes of article forms.

### SUMMARY

The present invention provides a dental article form that includes an organic composition in the form of a preformed (e.g., an anatomical shape), self-supporting (i.e., free-standing) structure that can be used to fabricate dental articles. If the dental article form is removable, then it is desirable for it to be thin walled (e.g., 0.05 mm to 0.25 mm thick). A dental article, for example, a dental crown, can be made quickly and easily according to the procedure described herein.

The present invention is appropriate for applications including, but not limited to, dental forms for dental restoratives and dental prostheses, including, but not limited to, temporary, intermediate, and permanent crowns and bridges, inlays, onlays, implants, dentures, and artificial teeth, as well as orthodontic appliances (e.g., retainers, night guards), tooth facsimiles or splints, maxillofacial prosthesis, and other customized structures.

The dental article form is typically removable, although this is not required. By this it is meant that after the dental article form is filled with a hardenable dental material and after the dental material is hardened to form a dental article, the dental article form can be removed from the article. Certain embodiments of the present invention allow for the dental article form to remain in place.

In general, if the form is not removable then the following characteristics become desirable: (1) clear/transparent or tooth colored (e.g., for crown and bridge); and (2) forms a strong interfacial bond (physical or chemical) to the hardened dental material (e.g., restorative material).

The organic composition of the dental article form can be curable or noncurable. If it is curable, it can include a wide variety of curable materials (e.g., monomers, oligomers, or polymerizable polymers), such as, an organic composition containing an ethylenically unsaturated component. The curable organic composition can also include one or more initiators. The dental article form includes a reservoir that is suitable for being filled with a hardenable dental material. If the organic composition is noncurable it can include a wide variety of noncurable polymers, such as, for example, those selected from the group consisting of a polycaprolactone, a polyvinylacetate, an ethylene-vinyl acetate copolymer, a polyethylene glycol, a wax, and mixtures thereof.

The organic composition can also include one or more fillers. The filler system can include, for example, fibers, particulate filler, or mixtures thereof. Suitable particulate material can be an inorganic material in the form of nanoscopic particles. In certain embodiments, the inorganic material can include surface hydroxyl groups.

If desired the organic composition can include other additives, such as, for example, one or more surfactants.

In one embodiment, the present invention provides a dental article form that includes an organic composition in the form of a self-supporting structure having a first shape and sufficient malleability to be formed into a second shape, wherein the dental article form is suitable for being filled with a hardenable dental material and removed after hardening the dental material to form a dental article.

In another embodiment, the present invention provides a noncurable organic composition in the form of a self-supporting structure having a first shape and sufficient malleability to be formed into a second shape, wherein the dental article form is suitable for being filled with one or more hardenable dental materials.

In another embodiment, the present invention provides a dental article form that includes an organic composition free of added filler in the form of a self-supporting structure having a first shape and sufficient malleability to be formed into a second shape, wherein the dental article form is suitable for being filled with one or more hardenable dental materials.

The present invention also provides a method of preparing a dental article, wherein the method includes: selecting a dental article form having a reservoir; filling the reservoir with one or more hardenable dental materials; placing the dental article form filled with one or more hardenable dental materials on a subject's tooth structure (that has been prepared for restoration, for example); at least partially hardening the hardenable material to form the dental article; optionally customizing the dental article outside of the subject's mouth; cementing the dental article to the subject's tooth structure; and optionally removing the dental article form; wherein the dental article form is reshaped while in the subject's mouth before or after filling the reservoir with the hardenable dental material.

Herein, the phrases “dental article form” and “dental form” refer to a device that is directly used to form an article (e.g. tooth) structure as opposed to first making an impression (in an impression tray). Thus, these phrases do not include dental impression trays because a customizable impression tray is used to make a negative impression of a tooth structure rather than a tooth structure itself and a customizable impression tray is not filled with a hardenable dental material, which becomes the dental article.

The term “self-supporting” means that the composition is dimensionally stable and will maintain its shape (e.g., preformed shape of a crown form) without significant deformation at room temperature (i.e., about 20° C. to about 25° C.) for at least about two weeks when free-standing (i.e., without the support of packaging or a container). Preferably, the compositions of the present invention are dimensionally stable at room temperature for at least about one month, and more preferably, for at least about six months. Preferably, the compositions of the present invention are dimensionally stable at temperatures above room temperature, more preferably up to about 40° C., even more preferably up to about 50° C., and even more preferably up to about 60° C. This definition applies in the absence of conditions that activate an initiator system (if present) and in the absence of an external force other than gravity.

The term “sufficient malleability” means that the self-supporting structure is capable of being custom shaped and fitted, for example, to a patient's mouth, under a moderate force (i.e., a force that ranges from light finger pressure to that applied with manual operation of a small hand tool, such as a dental composite instrument). Herein, the phrase “malleable” refers to a material that is malleable under conditions in the mouth or that can be comfortably withstood by oral tissue (e.g., temperature and/or oral fluids, including water).

The term “removable” refers to the capability of the dental article form (cured or uncured) to be removed from the hardened dental material that has been hardened (or partially hardened) within the reservoir of the form. It can be removed, for example, by peeling, abrading, sanding, dissolving, etc.

### DETAILED DESCRIPTION OF ILLUSTRATIVE EMBODIMENTS OF THE INVENTION

Preferably, the present invention provides a dental article form (i.e., dental form) that includes an organic composition in the form of a self-supporting (i.e., free-standing) structure having a first shape (e.g., in the form of a dental crown form) that includes a reservoir suitable for receiving a hardenable dental material. The components of the organic composition are chosen such that: the composition can be relatively easily molded to form the initial self-supporting structure having a reservoir; the self-supporting structure maintains its first shape at room temperature for at least about two weeks (in the absence of conditions that activate the initiator system, if present, and in the absence of an external force other than gravity), and the self-supporting structure has sufficient malleability (generally after the form is filled with a hardenable dental material) to be reformed into a second shape under conditions in the mouth or that can be comfortably withstood by oral tissue (e.g., temperature and/or oral fluids, including water). The compositions of the present invention also have sufficient strength and hydrolytic stability to render them suitable for use in the oral environment and to allow for hardening of the hardenable material in the reservoir to provide the desired dental article (e.g., a crown).

The compositions of the present invention are particularly well suited for preformed dental article forms. As used herein, a preformed dental article form is one that is provided to the dentist in the desired semi-finished, (preferably anatomically shaped for certain embodiments) (a first shape) having a reservoir for filling with a hardenable dental material, which can then be modified (e.g., reshaped, adapted, trimmed, or otherwise customized) into a second shape for fit in a patient. Herein, a semi-finished shape of a preformed dental article form is the facsimile of what the final shaped article is to be (preferably, a shape that is similar to the shape of a (human) body part), and is not the shape of a rope, globule, or sheet. Typically, this means that the compositions of the present invention have been formed into a shape, preferably using a mold with a positive and negative impression, and the resultant shaped material released from the shaping device, preferably a mold, without significant deformation.

Generally, self-supporting compositions of the present invention have rheological properties that allow them to be relatively easily deformed (i.e., they are malleable) and exhibit low elastic recovery. However, the compositions of the present invention are not free-flowing fluids (i.e., liquids) during modeling/reshaping (typically, this involves a temperature that is not above a temperature that can be comfortably withstood by oral tissue). Preferably, the compositions are not free flowing fluids above their softening points. For example, wax can be used in the present invention as long as the shape adaptation is done at ambient/body temperature. If the same wax were to be heated much higher (e.g., 80-90° C.), the wax would melt and turn into a free-flowing liquid. However, for certain embodiments, the compositions of the present invention display appreciable mass flow under moderate (e.g., hand) pressure, but not liquid flow above their softening points.

Typically, elastic and viscous dynamic moduli of compositions of the present invention vary over a wide range. Furthermore, the compositions are typically largely free from tack. Preferably, the elastic dynamic modulus (i.e., elastic modulus) G′ is at least about 100 kilopascals (kPa), more preferably, at least about 200 kPa, and most preferably, at least about 1000 kPa, at a frequency of about 0.005 Hz. Preferably, the elastic modulus G′ is no greater than about 50,000 kPa, more preferably, no greater than about 10,000 kPa, and most preferably, no greater than about 5000 kPa, at a frequency of about 0.005 Hz. Preferably, the viscous dynamic modulus (i.e., viscous modulus) G″ is at least about 50 kPa, more preferably, at least about 200 kPa, and most preferably, at least about 1000 kPa, at a frequency of about 0.005 Hz. Preferably, the viscous modulus G″ is no greater than about 50,000 kPa, more preferably, no greater than about 10,000 kPa, and most preferably, no greater than about 5000 kPa, at a frequency of about 0.005 Hz. These values are appropriate for certain embodiments only after the composition has been in contact with the oral environment (e.g., oral fluid and/or oral temperature).

The organic composition of the dental article form can be curable (e.g., polymerizable and/or crosslinkable) or noncurable.

Noncurable Compositions

If the organic composition is noncurable it can include a wide variety of noncurable compositions that provide sufficient malleability at mouth temperature. Preferred polymers have a molecular weight of at least 2,000. More preferred polymers have a molecular weight of no greater than 10,000. Examples include, but are not limited to, those selected from the group consisting of a polycaprolactone, a polyvinylacetate, an ethylene-vinyl acetate copolymer, a polyethylene glycol, a wax, and mixtures thereof. Suitable waxes include dental waxes such as pattern wax, base-plate wax, sheet wax, impression wax, study wax, and the like. Such waxes typically include blends of paraffin, microcystalline waxes, carnauba wax, ceresin, beeswax, and the like.

Other suitable noncurable materials for use in the organic compositions of the dental article forms of the present invention are those described in U.S. Pat. No. 6,057,383 (Volkel et al.), U.S. Pat. No. 5,403,188 (Oxman et al.), and U.S. Patent Publication No. 2002/0061493 (Sun et al.), which could be used as noncurable maerials if the initiator is not included in the composition

Curable Compositions (Resin Systems)

If the organic composition is curable, it can include a wide variety of curable materials (e.g., monomers, oligomers, or polymerizable polymers), such as, for example, more or more ethylenically unsaturated components (i.e., a resin system). Although, in this context oligomers and polymers are both used, the terms “polymer” and “polymeric” are used herein to refer to any materials having 2 or more repeat units, thereby encompassing oligomers. Thus, unless otherwise specified, polymers include oligomers. Furthermore, the term polymer is used herein to encompass both homopolymers and copolymers, and the term copolymer is used herein to encompass materials with two or more different repeat units (e.g., copolymers, terpolymers, tetrapolymers). The curable organic composition can also include one or more initiators (i.e., an initiator system). Once the dental article form is reformed into a second shape (if necessary or desired), the organic composition of the dental article form can be cured using, for example, a free radical curing mechanism under standard photopolymerization conditions to form a cured dental article form. Typically, the reforming (i.e., reshaping) occurs after the reservoir of the dental article form is filled with a hardenable dental material. The hardenable dental material can be hardened before, after, or at the same time as the curing of the organic composition of the dental article form.

Preferably, at least some of the components of the resin system include ethylenic unsaturation and are capable of undergoing addition polymerization. A suitable resin preferably includes at least one ethylenically unsaturated monomer (i.e., includes at least one carbon-carbon double bond).

Examples of suitable polymerizable resin components include: mono-, di-, or poly-(meth)acrylates (including acrylates and methacrylates) such as methyl acrylate, methyl methacrylate, ethyl acrylate, isopropyl methacrylate, n-hexyl acrylate, stearyl acrylate, allyl acrylate, glycerol mono- and diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis(1-(2-acryloxy))-p-ethoxyphenyldimethylmethane, bis(1-(3-acryloxy-2-hydroxy))-p-propoxyphenyldimethylmethane, tris(hydroxyethylisocyanurate) trimethacrylate, 2-hydroxyethyl methacrylate, 2-hydroxypropyl methacrylate, tetrahydrofurfuryl methacrylate, ethylene glycol dimethacrylate, triethylene glycol dimethacrylate, bisGMA, ethoxylated bisphenolA diacrylate, ethoxylated bisphenolA dimethacrylate, polyethylene glycol dimethacrylate, the bis-acrylates and bis-methacrylates of polyethylene glycols of molecular weight 200-500, copolymerizable mixtures of acrylated monomers such as those of U.S. Pat. No. 4,652,274 (Boettcher et al.), and acrylated oligomers such as those of U.S. Pat. No. 4,642,126 (Zador); unsaturated amides such as (meth)acrylamides (i.e., acrylamides and methacrylamides), methylene bis-acrylamide, methylene bis-methacrylamide, 1,6-hexamethylene bis-acrylamide, diethylene triamine tris-acrylamide, and beta-methacrylamidoethyl methacrylate, diacetone acrylamide, and diacetone methacrylamide; urethane (meth)acrylates; and vinyl compounds such as styrene, diallyl phthalate, divinyl succinate, divinyl adipate, and divinylphthalate. Mixtures of two or more such components can be used if desired in the resin system.

Preferably, the total amount of the resin is at least about 10 wt-%, more preferably, at least about 13 wt-%, and most preferably, at least about 15 wt-%, based on the total weight of the composition. Preferably, the total amount of the resin is no greater than about 60 wt-%, more preferably, no greater than about 50 wt-%, and most preferably, no greater than about 40 wt-%, based on the total weight of the composition. For certain embodiments, the total amount of resin is 100 wt-%.

Other suitable materials for use in the curable organic compositions of the dental article forms are those described in U.S. Pat. No. 6,057,383 (Volkel et al) U.S. Pat. No. 5,403,188 (Oxman et al.), U.S. Publication No. 2002/0061493 (Sun et al.), and U.S. patent application Ser. No. 10/219,398, filed on Aug. 15, 2002, entitled “Hardenable Self-Supporting Structures and Methods.”

Initiators

If the organic composition of the dental article form is curable, then one or more appropriate initiators (i.e., initiator system) are included. One initiator or a mixture of two or more initiators, which are capable of curing (e.g., polymerizing and/or crosslinking) of the resin system of the curable organic composition of the dental form, can be used. The initiators are preferably free radical initiators, which may be activated in a variety of ways, e.g., heat and/or radiation. Thus, for example, the initiator(s) can be thermal initiator(s) (e.g., azo compounds and peroxides), or photoinitiator(s). Optionally, the initiator system includes one or more photoinitiators. The initiator system can include at least one photoinitiator active in the spectral region of about 300 nanometers (nm) to about 1200 nm and capable of promoting free radical polymerization and/or crosslinking of ethylenically unsaturated moieties upon exposure to light of suitable wavelength and intensity. A wide variety of such photoinitiators can be used. The photoinitiator preferably is soluble in the resin system. Preferably, they are sufficiently shelf stable and free of undesirable coloration, although discoloration is not an issue unless the form is non-removable, to permit storage and use under typical dental operatory and laboratory conditions. Visible light photoinitiators are preferred.

Examples of suitable initiators are described in U.S. patent application Ser. No. 10/219,398, filed on Aug. 15, 2002, entitled “Hardenable Self-Supporting Structures and Methods.”

The initiator system is present in an amount sufficient to provide the desired rate of curing (e.g., polymerizing and/or crosslinking). For a photoinitiator, this amount will be dependent in part on the light source, the thickness of the layer to be exposed to radiant energy, and the extinction coefficient of the photoinitiator.

Preferably, the initiator system is present in a total amount of at least about 0.01 wt-%, more preferably, at least about 0.03 wt-%, and most preferably, at least about 0.05 wt-%, based on the weight of the composition. Preferably, the initiator system is present in a total amount of no more than about 10 wt-%, more preferably, no more than about 5 wt-%, and most preferably, no more than about 2.5 wt-%, based on the weight of the composition.

Fillers

Optional fillers (i.e. filler systems) for use in the organic composition of the dental article forms may be selected from a wide variety of conventional fillers. Preferably, the fillers are those suitable for incorporation in compositions used for medical applications, for example, fillers currently used in dental restorative compositions.

Fillers may be either particulate or fibrous in nature. Particulate fillers may generally be defined as having a length to width ratio, or aspect ratio, of 20:1 or less, and more commonly 10:1 or less. Fibers can be defined as having aspect ratios greater than 20:1, or more commonly greater than 100:1. The shape of the particles can vary, ranging from spherical to ellipsoidal, or more planar such as flakes or discs. The macroscopic properties can be highly dependent on the shape of the filler particles, in particular the uniformity of the shape.

In certain embodiments particulate filler is finely divided and has an average particle size (preferably, diameter) of less than about 10 micrometers (i.e., microns). Suitable micron-size particulate filler has an average particle size of at least about 0.2 microns up to 1 micrometers. Nanoscopic particles have an average primary particle size of less than 200 nm (0.2 microns). The filler can have a unimodal or polymodal (e.g., bimodal) particle size distribution.

Examples of suitable fillers are described in U.S. patent application Ser. No. 10/219,398, filed on Aug. 15, 2002, entitled “Hardenable Self-Supporting Structures and Methods.”

Optionally, the surface of the filler particles may be treated with a surface treatment, such as a silane-coupling agent, in order to enhance the bond between the filler and the resin system. The coupling agent may be functionalized with reactive curing groups, such as acrylates, methacrylates, and the like.

If one or more fillers are used, the total amount used can be any amount suitable for the desired article form, even up to as high as 90 wt-% if desired.

Other Optional Additives

The organic compositions of the invention may contain one surfactant or a mixture of two or more surfactants. These surfactants, when used in small amounts may interact with other components of the composition, such as an inorganic filler material, to enhance the formation of a noncovalent three-dimensional structure. Such surfactants can be nonionic, anionic, or cationic. The surfactant(s) can be copolymerizable with the resin system or non-copolymerizable. A consideration in the choice of a surfactant that can be used is the degree to which the ingredients of the system are able to participate in hydrogen bonding.

The organic composition may additionally include optional agents such as colorants (e.g., pigments conventionally used for shade adjustment), flavorants, medicaments, stabilizers (such as butylated hydroxyl toluene (BHT)), viscosity modifiers, and the like. Such agents may optionally include reactive functionality so that they will be copolymerized with the resin system.

Methods of Use and Products

The present invention provides a method of preparing a dental article, wherein the method includes: selecting a dental article form having a reservoir; filling the reservoir with one or more hardenable dental materials; placing the dental article form filled with one or more hardenable dental materials on a subject's tooth structure (that has been prepared for restoration, for example); at least partially hardening the hardenable material to form the dental article; optionally customizing the dental article outside of the subject's mouth; cementing the dental article to the subject's tooth structure; and optionally removing the dental article form; wherein the dental article form is reshaped while in the subject's mouth before or after filling the reservoir with the hardenable dental material.

In an exemplary embodiment, the tooth to be restored is prepared for restoration (e.g., a full crown restoration), and then both the tooth and the surrounding tissue are coated with a petroleum jelly. An appropriate shape and size of a dental article form (e.g., crown form) are selected and the resulting form is seated on the prepared tooth to determine the extent of trimming and shaping required, optionally making marks on the dental article form. The article form is removed from the mouth, the required shape and size adjustments are made by cutting, trimming, shaping, etc., filled with a hardenable dental material and then re-seated on the tooth preparation. Excess dental material can flow out, either at the gingival margin or through a pre-designed opening or vent on the dental crown form. The dental article form is sufficiently malleable in the oral environment such that the filled article form is easily customizable, which includes, for example, adjustment to width and marginal contacts of the crown form. This customization is done while the filled dental article form is seated on the prepared tooth stump, and while the hardenable dental material is still in the unhardened stage. The customization can be done by a variety of methods including applying pressure with fingers or an instrument of choice (e.g., hand operation of dental composite instrument) to provide optimum custom fit, including gingival, proximal, and occlusal fit. After cleaning up the excess dental material, the remaining dental material inside the dental article form is tack cured (i.e., partially cured) in case of a light curable material with a light gun, or let partially cure if a self-cure dental material is used. Then the dental article form containing the dental material is removed from the tooth prep, followed by further hardening of the hardenable dental material, if necessary. The dental article form is separated and removed, and then the now hardened dental material is further trimmed and polished as necessary to obtain the final dental article (e.g., crown). This dental article can then be seated on the cleaned tooth stump with cement.

The dental article form can be provided to the dentist already filled with one or more hardenable dental materials for making a desired dental article. Thus, the dentist would not have to fill the dental article form with a hardenable dental material. Alternatively, an unfilled dental article form could be provided, such that the dentist would have the flexibility to fill the form with a hardenable dental material of choice before use. This is of particular interest for fabricating a dental crown, because it allows the dentist to use a hardenable dental material of preferred shade, including the use of combinations of more than one hardenable dental material.

Use of more than one hardenable dental material in a single dental article form offers several advantages. In case of a dental crown, a combination of materials of different shades and translucencies may provide a highly aesthetic article, e.g. by mimicking dentin and enamel layers of a natural tooth. Similarly, use of hardenable dental materials of different viscosities and handling characteristics (in the same dental article form) can provide ease of use and/or better functional properties. For example, in the case of a dental crown form, the occlusal region of the crown form could be filled with a low wear, highly filled dental resin.

The shaped articles can be sold individually or in multiple units, preferably packaged in a way that protects them from heat and/or light that can activate the initiator system contained in the compositions that are curable or if the dental article forms are prefilled with a hardenable dental material. Examples of suitable curable hardenable dental materials that may be used in connection with the present invention include, e.g., the photopolymerizable and chemically polymerizable compositions disclosed for use as hardenable dental materials (restoratives, fillers, etc.) as described in, e.g., U.S. patent application Ser. No. 10/185,431 filed Jun. 28, 2002 (Oxman et al.) titled PROCESSES FOR FORMING DENTAL MATERIALS AND DEVICE; as well as U.S. Pat. No. 6,084,004 (Weinmann et al.) and U.S. Pat. No. 6,187,836 (Oxman et al.).

The self-supporting dental article forms of this invention can be prepackaged either individually or as an ensemble. Such packaging material should protect these products from conditions that would activate the initiator system, if present, and thus cause premature hardening, e.g., such as could result from exposure to light in the case of a photoinitiator. In addition, the packaging material optionally conforms to the surfaces of the dental article form, thereby providing additional mechanical strength in order to resist damage during shipping. For example, a dental article form could be packaged in a layer of polyethylene on all sides. The polyethylene provides a mechanical structure and can be sealed to avoid contact with water. If the polyethylene were filled with an appropriate dye, e.g., carbon black, incident light would be absorbed before it could reach the enclosed product. If such a packaging layer is somewhat rigid, and if the packaging material is shaped similar to the dental article form of the invention, then the packaging could enhance the dimensional stability of the dental article form during shipment and storage. In certain cases, the packaging may thus form an integral part of the product system.

The dental article form can be transported in packaging, such as light-blocking packaging for photocurable organic compositions.

The dental article forms may include one or more of the following features: a handle attached to the dental article (preferably, crown) form at a location removed from the base of the dental article form; a vented handle through which excess amounts of hardenable dental material can pass during placement of the dental article form; and one or more lines of weakness that may be separated to remove a dental article form from dental material after placement of the filled dental article form. These embodiments are more fully described with respect to dental crown forms in Applicants' Assignee's copending U.S. Patent Application Serial No. ______, filed on even date herewith, entitled “Dental Crown Forms and Methods” (Attorney Docket No. 58449US001).

If the dental article form is removable, then it is desirable for it to be thin walled. Preferably, it would not have a thickness greater than 0.25 millimeters (mm) thick. It could be extremely thin, even as thin as 0.05 mm thick. If the dental article form is not removable, then it is desirable for it to be clear or transparent. Alternatively, it could be tooth colored if the dental article is a crown or a bridge, for example. Furthermore, if it is not removable it should be capable of forming a strong interfacial bond (physical or chemical) to the hardened dental material (e.g., restorative material).

### EXAMPLE

A preformed, polycarbonate crown (maxillary right central incisor, #100 from 3M ESPE, St. Paul, Minn.) was filled with a silicone impression material (3M IMPRINT II Wash Material—Regular Viscosity, 3M ESPE) and allowed to set. The hardened silicone core was carefully removed from inside the polycarbonate crown in one piece and was used as the mold around which a malleable crown form was made as follows.

A 0.2 mm thick and 4 mm by 1.5 mm piece was cut from a wax sheet (Modeling Wax in Plates, 0.2 from Friedrich Krupp GmbH Widia-Fabrik, Essen, Germany. This wax film was wrapped around the above-described silicone tooth mold creating a small vertical overlap of the two ends of the wax sheet. The wax was slightly heated and the overlap welded together, thereby creating a tube-like structure. Then, the tube was sealed along the incisor edge of the crown mold to make a rough crown-like shape. The softened wax could then be easily adapted around the tooth shaped silicone mold. All excess wax was trimmed off and the silicone mold carefully removed to produce a thin-walled, malleable crown form of the invention.

This malleable crown form was adapted to a TYPODONT arch model (Columbia Dentoform, Long Island City, N.Y.), whose maxillary central incisor was prepared for a full crown, by trimming with scissors at the gingival margin to the appropriate length. The crown form was then filled with an automixed visacrylic temporary material (PROTEMP 3 GARANT from 3M ESPE) and seated over the prepared tooth stump, which was previously coated with a petroleum jelly. When the temporary material had reached an intermediate hardened stage, the crown was carefully removed from the tooth and the excess material that had squeezed out was trimmed. After several more minutes, the wax crown form was removed from the cured crown thereby obtaining a composite crown.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A dental article form comprising an organic composition in the form of a self-supporting structure having a first shape and sufficient malleability to be formed into a second shape, wherein the dental article form is capable of being filled with one or more hardenable dental materials and removed after at least partially hardening the dental material to form a dental article.

2. The dental article form of claim 1 wherein the organic composition is curable.

3. The dental article form of claim 2 wherein the curable organic composition comprises an initiator system and a resin system comprising at least one ethylenically unsaturated component.

4. The dental article form of claim 1 wherein the organic composition is noncurable.

5. The dental article form of claim 4 wherein the noncurable organic composition comprises a noncurable polymer selected from the group consisting of a polycaprolactone, a polyvinylacetate, an ethylene-vinyl acetate copolymer, a polyethylene glycol, a wax, and mixtures thereof.

6. The dental article form of claim 1 wherein the organic composition comprises a filler system.

7. The dental article form of claim 6 wherein the filler system comprises fibers, particulate filler, or mixtures thereof.

8. The dental article form of claim 6 wherein the filler system comprises an inorganic material comprising nanoscopic particles.

9. The dental article form of claim 8 wherein the inorganic material comprises surface hydroxyl groups.

10. The dental article form of claim 1 wherein the organic composition further comprises a surfactant system.

11. The dental article form of claim 1 which is a form for a dental article selected from the group consisting of a crown, an inlay, an onlay, a bridge, an orthodontic appliance, a maxillofacial prosthesis, and a tooth splint.

12. The dental article form of claim 1 comprising a reservoir containing the one or more hardenable dental materials.

13. The dental article form of claim 1 which is in packaging.

14. The dental article form of claim 13 wherein the packaging is light-blocking packaging.

15. The dental article form of claim 1 comprising one or more of the following features: a handle attached to the dental article form at a location removed from the base of the dental article form; a vented handle through which excess amounts of hardenable dental material can pass during placement of the dental article form; and one or more lines of weakness that may be separated to remove the dental article form from dental material after placement of the dental article form.

16. A dental article form comprising a noncurable organic composition in the form of a self-supporting structure having a first shape and sufficient malleability to be formed into a second shape, wherein the dental article form is suitable for being filled with one or more hardenable dental materials.

17. The dental article form of claim 16 wherein the noncurable organic composition comprises a noncurable polymer selected from the group consisting of a polycaprolactone, a polyvinylacetate, an ethylene-vinyl acetate copolymer, a polyethylene glycol, a wax, and mixtures thereof.

18. The dental article form of claim 16 wherein the noncurable organic composition comprises a filler system.

19. The dental article form of claim 18 wherein the filler system comprises fibers, particulate filler, or mixtures thereof.

20. The dental article form of claim 18 wherein the filler system comprises an inorganic material comprising nanoscopic particles.

21. The dental article form of claim 20 wherein the inorganic material comprises surface hydroxyl groups.

22. The dental article form of claim 16 which is a form for a dental article selected from the group consisting of a crown, an inlay, an onlay, a bridge, an orthodontic appliance, a maxillofacial prosthesis, and a tooth splint.

23. The dental article form of claim 16 comprising a reservoir containing one or more hardenable dental materials.

24. The dental article form of claim 16 which is nonremovable.

25. The dental article form of claim 16 which is in packaging.

26. The dental article form of claim 16 which is removable after at least partially hardening the dental material to form a dental article.

27. The dental article form of claim 16 comprising one or more of the following features: a handle attached to the dental article form at a location removed from the base of the dental article form; a vented handle through which excess amounts of hardenable dental material can pass during placement of the dental article form; and one or more lines of weakness that may be separated to remove the dental article form from dental material after placement of the dental article form.

28. A dental article form comprising an organic composition free of added filler in the form of a self-supporting structure having a first shape and sufficient malleability to be formed into a second shape, wherein the dental article form is suitable for being filled with one or more hardenable dental materials.

29. The dental article form of claim 28 wherein the organic composition free of added filler is curable.

30. The dental article form of claim 29 wherein the curable organic composition comprises an initiator system and a resin system comprising at least one ethylenically unsaturated component.

31. The dental article form of claim 28 wherein the organic composition free of added filler is noncurable.

32. The dental article form of claim 30 wherein the noncurable organic composition comprises a noncurable polymer selected from the group consisting of a polycaprolactone, a polyvinylacetate, an ethylene-vinyl acetate copolymer, a polyethylene glycol, a wax, and mixtures thereof.

33. The dental article form of claim 28 which is nonremovable.

34. The dental article form of claim 28 comprising a reservoir containing one or more hardenable dental materials.

35. The dental article form of claim 28 which is a form for a dental article selected from the group consisting of a crown, an inlay, an onlay, a bridge, an orthodontic appliance, a maxillofacial prosthesis, and a tooth splint.

36. The dental article form of claim 28 which is in packaging.

37. The dental article form of claim 28 which is removable after hardening the dental material to form a dental article.

38. The dental article form of claim 28 comprising one or more of the following features: a handle attached to the dental article form at a location removed from the base of the dental article form; a vented handle through which excess amounts of hardenable dental material can pass during placement of the dental article form; and one or more lines of weakness that may be separated to remove the dental article form from dental material after placement of the dental article form.

39. A method of preparing a dental article, the method comprising:
selecting a dental article form having a reservoir;
filling the reservoir with one or more hardenable dental materials;
placing the dental article form filled with one or more hardenable dental materials on a subject's tooth structure;
at least partially hardening the hardenable material to form the dental article;
optionally customizing the dental article outside of the subject's mouth;
cementing the dental article to the subject's tooth structure; and
optionally removing the dental article form;
wherein the dental article form is reshaped while in the subject's mouth before or after filling the reservoir with the hardenable dental material.

40. The method of claim 39 wherein the dental article form is removed.

41. The method of claim 39 wherein the dental article form comprises an organic composition in the form of a self-supporting structure having a first shape and sufficient malleability to be formed into a second shape.

42. The method of claim 41 wherein the organic composition is curable.

43. The method of claim 42 wherein the curable organic composition comprises an initiator system and a resin system comprising at least one ethylenically unsaturated component.

44. The method of claim 41 wherein the organic composition is noncurable.
